(19) United States
(12) Patent Application Publication
(10) Pub. No.: US 2026/0138773 A1
(43) Pub. Date: May 21, 2026

(54) Rounded Container with Square Top and Method for Using the Same

(71) Applicant: Cambro Manufacturing Company, Huntington Beach, CA (US)

(72) Inventors: Jeff Munson, Laguna Nigel, CA (US); Charles W. Jarvis, Irvine, CA (US)

(21) Appl. No.: 18/954,231

(22) Filed: Nov. 20, 2024

(51) Int. Cl. B65D 1/18; B65D 25/32

(52) U.S. Cl. CPC B65D 1/18; B65D 25/32

(57) ABSTRACT

A container having a cylindrical shaped body with a rim disposed around a circumference of the body and forming an opening of the container. At least one hold is defined within the rim along with a plurality of bail flanges. The rim has a substantially square shape when viewed from a top down position and a plurality of side walls formed together with a corresponding plurality of corners. Each corner may include a curved inner surface and is disposed between two adjacent side walls each comprising a flat inner surface, thereby forming a funnel when the container is rotated relative to a horizontal axis of the body. As the container is rotated, a user may maintain a high degree of control using the hold defined in the rim as liquid or other substances are being poured from the container.

### BACKGROUND

### Field of the Technology

The invention relates to the field of containers and household items, and in particular containers for providing smooth and consistent fluid flow therefrom.

### Description of the Prior Art

Containers and receptacles have long been used to store, transport, and dispense all manner of different fluids and liquids. Containers such as buckets, cans, or drums may include a bail, a handle, or other means for a user to grab or pick up the container without touching the main body of the container itself. Many of these containers may also include a spout, funnel, or other molded component that may be removably attached to the container or defined into the contours of the side, lip, or rim of the container in order to assist with pouring liquids from the container. Most traditional containers for holding liquids are substantially cylindrical so as to provide a maximum internal volume, however many others may include a substantially cube or cuboidal shape instead. Many traditional containers may be made from plastic or plastic composites, however other containers may be comprised of metal, wood, or other appropriate materials.

However, containers that are used for liquids which have a cylindrical body or volume also have a circular opening, meaning that when the container is tilted at an angle in order to pour the liquid out, the liquid may be unevenly dispensed from the container due to the arc or curvature of the edge of the circular opening. For example, a traditional can of paint when disposed at an angle can lead to the paint being poured unevenly which may result in spills and greater inconvenience. Conversely, containers that are used for liquids which have a cuboidal body or volume have a square opening which may lead to greater than intended volumes of liquid being poured when the container is disposed at an angle due to the substantially flat edges of the square opening. The user may choose to rotate the container as the liquid is being poured therefrom so as to take advantage of a wedge-shape corner of the square shaped opening, however this can be impractical under certain circumstances, particularly when the container is full and may be too heavy to manipulate. Furthermore, while bails or handles are provided on many containers, a user wishing to tilt the container at an angle must hold the bail or handle with one hand so as to raise the container and then use their other hand to rotate the container relative to the bail or handle. Because many containers have smooth surfaces, this forces the user to grip a bottom portion of the container which in turn may lead to imprecise control of the flow of liquid being poured out of the container. Additionally, because the user has had to touch the bottom of the container, any debris or substance that the container may have previously been sitting in or on may now touch the user's hands, leading to further inconvenience.

What is needed is container for holding and dispensing liquids which has a maximum available storage volume but which is still easy to manipulate and maintain control while pouring liquid from the container.

### BRIEF SUMMARY

The current invention includes a container which has a cylindrical shaped body, according to certain embodiments. A rim may be disposed around a circumference of the body and form an opening of the container. In certain embodiments, at least one hold is defined within the rim along with a plurality of bail flanges, wherein the hold is disposed between at least two of the bail flanges. The container includes a bail that is coupled to each of the plurality of bail flanges and a handle that is in turn coupled to the bail. According to certain embodiments, the plurality of bail flanges and the at least one hold are vertically adjacent to a different corner of the rim. The at least one hold may also include a hollow cavity defined therein which is configured to accommodate a user. According to certain embodiments, the rim includes a substantially square shape when viewed from a top down position and a plurality of side walls formed together with a corresponding plurality of corners, wherein each corner comprises a curved inner surface and is disposed between two adjacent side walls each comprising a flat inner surface. In certain embodiments, each corner disposed between two adjacent side walls may form a funnel when the container is rotated relative to a horizontal axis of the body.

While the apparatus and method has or will be described for the sake of grammatical fluidity with functional explanations, it is to be expressly understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112 are to be accorded full statutory equivalents under 35 USC 112. The disclosure can be better visualized by turning now to the following drawings wherein like elements are referenced by like numerals.

### BRIEF DESCRIPTION OF THE DRAWINGS

FIG. 1 is a perspective view of the container of the current invention, according to an embodiment.

FIG. 2 is a frontal view of the container seen in FIG. 1.

FIG. 3 is a right side view of the container seen in FIG. 1.

FIG. 4 is a bottom-up view of the container seen in FIG. 1.

FIG. 5 is a top-down view of the container seen in FIG. 1.

FIG. 6 is a right side view of the container as it is being simultaneously lifted and rotated by a user in order to pour a liquid or other substance therefrom, according to an embodiment.

FIG. 7 is a frontal view of the container seen in FIG. 6 as liquid or another substance is poured therefrom, the side edges and a rounded corner of a rim of the container forming a funnel shape for the liquid or substance being poured.

The disclosure and its various embodiments can now be better understood by turning to the following detailed description of the preferred embodiments which are presented as illustrated examples of the embodiments defined in the claims. It is expressly understood that the embodiments as defined by the claims may be broader than the illustrated embodiments described below.

### DETAILED DESCRIPTION OF THE PREFERRED EMBODIMENTS

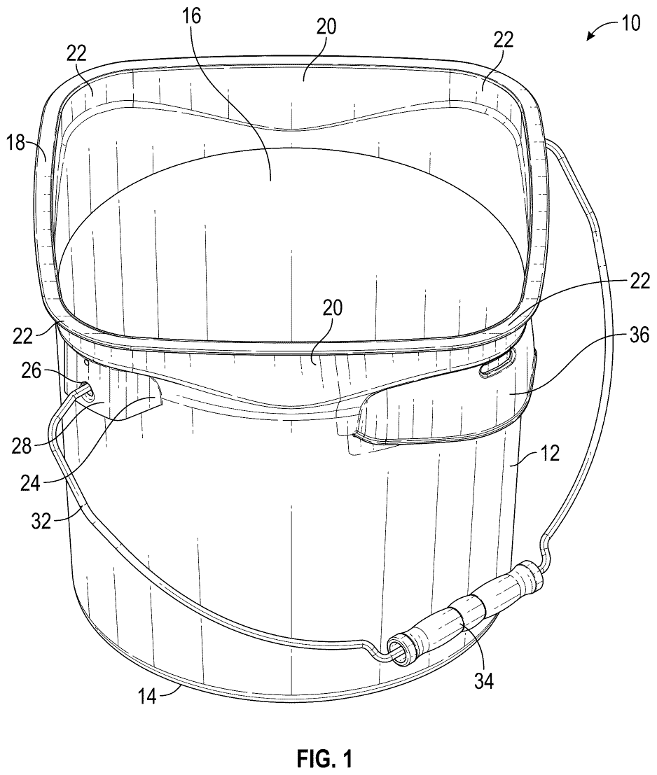

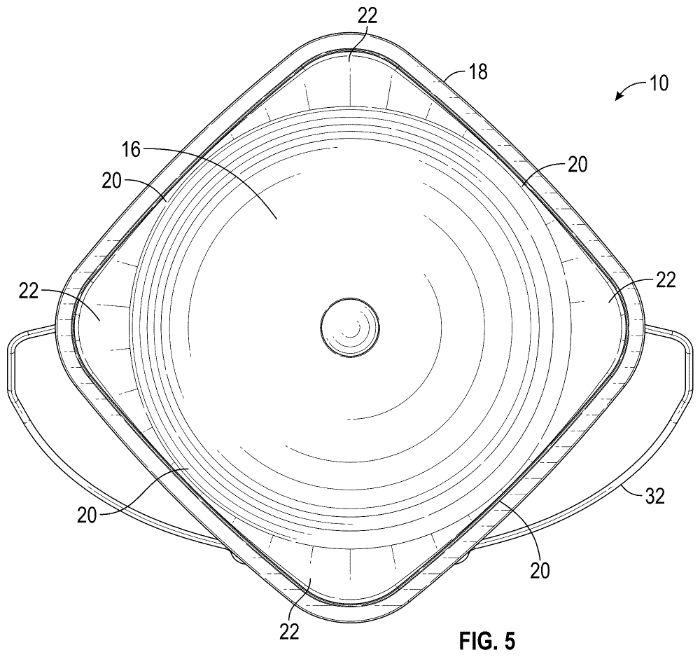

FIGS. 1-5 are perspective, side, frontal, bottom up, and top down views, respectively, of a container of the current invention, the container being denoted in general by reference numeral 10. The container 10 includes a substantially cylindrical body 12 with a bottom portion 14 that together define an internal volume 16 capable of accommodating liquids, fluids, or other items or substances therein. An upper portion of the container 10 includes a substantially square shaped rim 18 which forms an opening of the container 10. According to certain embodiments, the rim 18 includes four substantially identical side walls 20 joined together through a corresponding plurality of substantially identical corners 22. In some embodiments, each corner 22 may include a substantially rounded surface or edge so as to provide a curved transition between adjacent side walls 20. According to certain embodiments, each of the corners 22 may include alternatively shaped contours or angled surfaces such as but not limited to triangular, circular, oval, elongated, tapered, funneled, square, parallelepiped, or a combination thereof. The container 10 may be comprised of plastic or plastic composites, however other materials such as metal, rubber, or other materials may be used without departing from the original spirit and scope of the invention.

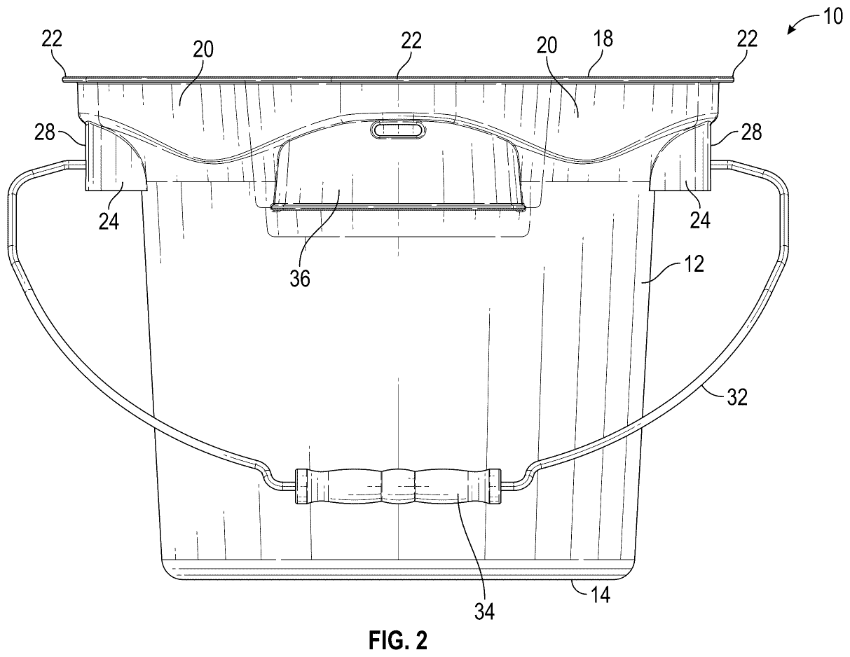

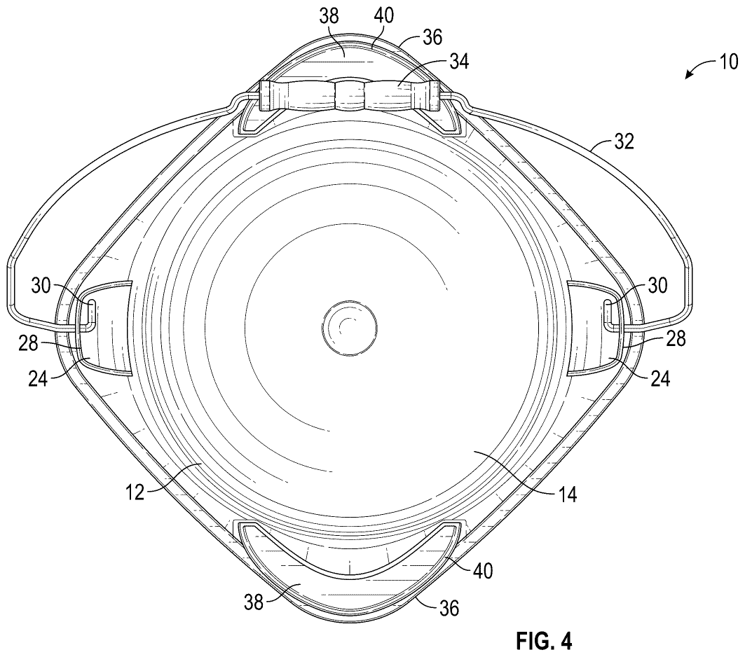

According to certain embodiments, the rim 18 may also include a pair of bail flanges 24 which are disposed on opposing sides of the container 10 from each other as best seen in FIGS. 2 and 4. Each bail flange 24 may be disposed directly beneath one of the corners 22 of the rim 18 and may be formed as a protrusion in or on the surface of the rim 18 itself. Each bail flange 24 may be hollow and also include a hole 26 defined in an outward facing surface 28, the hole 26 being configured to accommodate a hook portion 30 of a bail 32 therein. During use, as the bail 32 is rotated relative to the body 12, the hook portions 30 of the bail 32 freely rotate within each bail flange 24. In certain embodiments, the bail 32 in turn may be threaded through a handle 34 which allows a user to grip and pick up the container 10 when in use. The handle 34 may be shaped or include contours which assist the user in maintaining a grip on the handle 34. According to certain embodiments, the bail 32 may be comprised of metal or metal alloys, however equivalent materials such as rope, linen, or plastic may be used. Similarly, the handle 34 may be comprised of light weight plastic or plastic composites, however other suitable materials such as wood or metal may also be used as is known in the art.

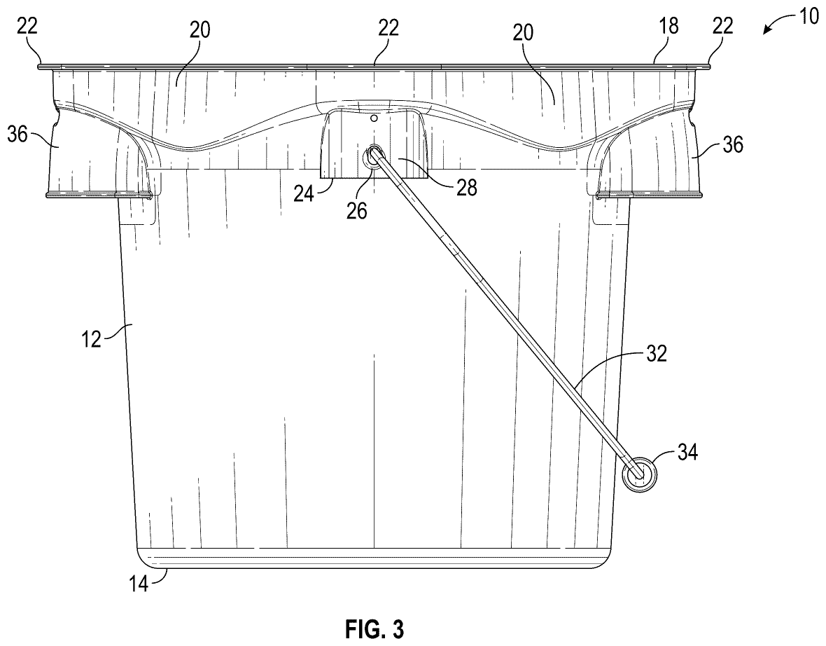

According to certain embodiments, the rim 18 of the container 10 may further include a pair of holds 36 disposed on opposing sides of the container 10 as best seen in FIGS. 3 and 4. Each hold 36 may be disposed directly beneath one of the corners 22 of the rim 18 and may be formed as a hollow protrusion in or on the surface of the rim 18 itself. According to certain embodiments and as seen in FIGS. 1-4, the holds 36 and the bail flanges 24 are disposed on alternating corners 22 of the rim 18 so that each bail flange 24 is disposed between each hold 36 and vice versa. Turning to FIG. 4, a bottom portion of each hold 36 may further include an opening or aperture 38 which allows the hands or fingers of a user to enter into a hollow cavity 40 defined within each hold 36 and grip the rim 18 of the container 10.

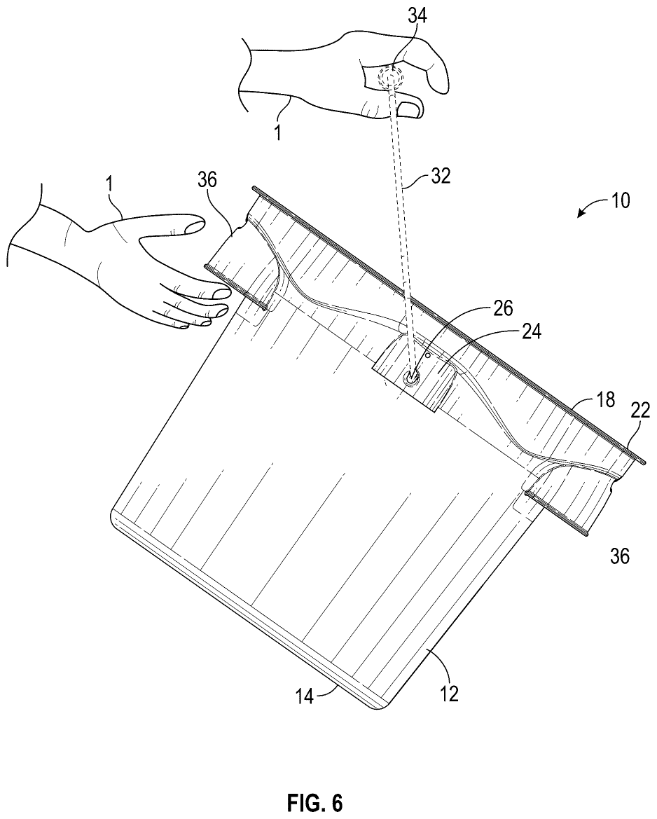

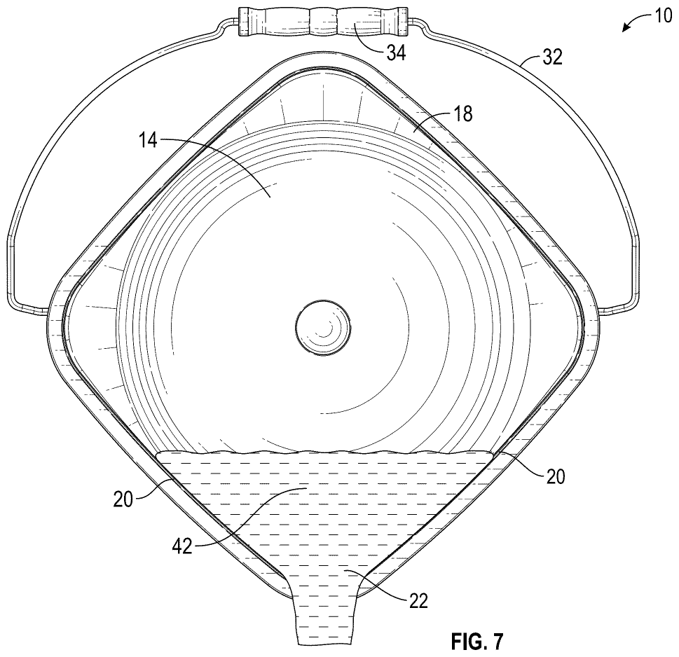

Use of the container 10 may seen in FIGS. 6 and 7. According to certain embodiments, a user 1 may use the container 10 by gripping the handle 34 and lifting it upwards which forces the bail 32 to rotate about the respective holes 26 defined within each bail flange 24. As the user 1 continues to lift upwards on the handle 34, the container 10 and any contents contained therein are also lifted upward. While holding the handle 34 with one hand, the user 1 may begin to rotate the body 12 relative to the bail 32 with their remaining hand. Specifically, the user 1 may insert their hand or their fingers into the opening 38 of the hollow cavity 40 of the hold 36 disposed on an opposite side of the container 10 in which the user 1 intends to pour liquid from. The user 1 may grip or press upward on an inside surface of the hollow cavity 40, which rotates the body 12 relative to the bail 34 which remains in a substantially vertical position as seen in FIG. 6.

As the container 10 is rotated or tipped in the direction desired by the user 1, the items, substances, or fluids 42 contained within the internal volume 16 begin to move toward the edge of the rim 18. According to certain embodiments and as best seen in FIG. 7, as the container 10 is rotated or tipped forward, the fluid 42 is directed toward a corner 22 by the adjacent side walls 20. In other words, because the corner 22 provides a curved transitional surface between two adjacent side walls 20, the side walls 20 form a funnel shape which directs the liquid 42 towards and then over the edge of the corner 22.

As the liquid 42 flows over the corner 22, the curvature of the corner 22 ensures that a smooth, continuous, and easily controllable fluid flow is provided by the container 10. For example, to decrease or increase the rate of liquid flowing over the corner 22 and out of the container 10, the user 1 may lower or further raise the opposing side of the body 12 via the hold 36, respectively. Such action may therefore provide a highly effective way for controlling the amount of liquid 42 that may be poured from the container 10. Additionally, because the corner 22 and side walls 20 cooperate to form a funnel shape that provides a cohesive fluid flow, and because the user 1 maintains at least one hand within the opposing hold 36, the user 1 may maintain a high degree of horizontal and vertical control over the container 10 as the liquid 42 is being poured therefrom. Such control may be particularly advantageous when the liquid 42 within the container 10 needs to be poured or distributed over a large surface area in an efficient and consistent manner.

Many alterations and modifications may be made by those having ordinary skill in the art without departing from the spirit and scope of the embodiments. Therefore, it must be understood that the illustrated embodiment has been set forth only for the purposes of example and that it should not be taken as limiting the embodiments as defined by the following embodiments and its various embodiments.

Therefore, it must be understood that the illustrated embodiment has been set forth only for the purposes of example and that it should not be taken as limiting the embodiments as defined by the following claims. For example, notwithstanding the fact that the elements of a claim are set forth below in a certain combination, it must be expressly understood that the embodiments includes other combinations of fewer, more or different elements, which are disclosed in above even when not initially claimed in such combinations. A teaching that two elements are combined in a claimed combination is further to be understood as also allowing for a claimed combination in which the two elements are not combined with each other, but may be used alone or combined in other combinations. The excision of any disclosed element of the embodiments is explicitly contemplated as within the scope of the embodiments.

The words used in this specification to describe the various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptionally equivalent, what can be obviously substituted and also what essentially incorporates the essential idea of the embodiments.

We claim:

1. A container comprising:
a body;
a rim disposed around a circumference of the body and forming an opening of the container; and
at least one hold defined within the rim,
wherein the rim comprises a substantially square shape when viewed from a top down position.

2. The container of claim 1, wherein the rim comprises a plurality of side walls formed together with a corresponding plurality of corners, wherein each corner is disposed between two adjacent side walls.

3. The container of claim 2, wherein each of the plurality of corners comprises a curved inner surface and wherein each of the plurality of side walls comprises a flat inner surface.

4. The container of claim 1, further comprising a plurality of bail flanges defined in the rim, wherein the hold is disposed between at least two of the bail flanges.

5. The container of claim 4, wherein the plurality of bail flanges and the at least one hold are vertically adjacent to a different corner of the rim.

6. The container of claim 1, wherein the at least one hold comprises a hollow cavity defined therein configured to accommodate a user.

7. The container of claim 2, further comprising:
a bail coupled to each of the plurality of bail flanges; and
a handle coupled to the bail.

8. The container of claim 2, wherein each corner disposed between two adjacent side walls forms a funnel when the container is rotated relative to a horizontal axis of the body.

9. The container of claim 1, wherein the rim further comprises:
a pair of holds disposed on a first pair of opposing corners of the rim; and
a pair of bail flanges disposed on a second pair of opposing corners of the rim,
wherein the first pair of opposing corners of the rim are disposed between the second pair of opposing corners of the rim.

10. The container of claim 1, wherein the body comprises a cylindrical shape.

11. A method for using a container, the method comprising:
lifting a container comprising a substance disposed within an internal volume of a body of the container;
rotating the container about a horizontal axis of the body;
pouring the substance from the container;
maintaining the body at an angled orientation for as long as the substance is being poured from the container; and
disposing the body at a vertical orientation to stop the pouring of the substance from the container.

12. The method of claim 11, wherein pouring the substance from the container comprises pouring the substance over a substantially square shaped rim disposed on the body, 13. The method of claim 12, wherein the pouring the substance over a substantially square shaped rim disposed on the body comprises pouring the substance over a corner of the substantially square shaped rim.

14. The method of claim 11, wherein lifting a container comprising a substance disposed within an internal volume of a body of the container comprises lifting a bail coupled to a rim disposed on the body.

15. The method of claim 14, wherein rotating the container about a horizontal axis of the body comprises rotating the container relative to the bail.

16. The method of claim 15, wherein rotating the container relative to the bail comprises rotating a pair of bail flanges disposed on the rim relative to the bail.

17. The method of claim 11, wherein rotating the container about a horizontal axis of the body comprises lifting upwards on a hold defined within a rim disposed on the body.

18. The method of claim 17, wherein lifting upwards on a hold defined within a rim disposed on the body comprises lifting upwards on a hold that is defined on an opposing side of the rim relative to a portion of the rim which is used to pour substance from the container.

19. The method of claim 17, wherein maintaining the body at an angled orientation for as long as the substance is being poured from the container comprises lifting upwards on the hold for as long as the substance is being poured from the container.

20. A container comprising:
a cylindrical shaped body;
a rim disposed around a circumference of the body and forming an opening of the container;
at least one hold defined within the rim;
a plurality of bail flanges defined in the rim, wherein the hold is disposed between at least two of the bail flanges;
a bail coupled to each of the plurality of bail flanges; and
a handle coupled to the bail,
wherein the plurality of bail flanges and the at least one hold are vertically adjacent to a different corner of the rim,
wherein the at least one hold comprises a hollow cavity defined therein configured to accommodate a user,
wherein the rim comprises:
a substantially square shape when viewed from a top down position; and
a plurality of side walls formed together with a corresponding plurality of corners, wherein each corner comprises a curved inner surface and is disposed between two adjacent side walls each comprising a flat inner surface,
wherein each corner disposed between two adjacent side walls forms a funnel when the container is rotated relative to a horizontal axis of the body.
